(19) United States
(12) Patent Application Publication
(10) Pub. No.: US 2013/0014132 A1
(43) Pub. Date: Jan. 10, 2013

(54) OPTICAL DISK DEVICE

(75) Inventors: Masaomi INOUE, Fukuoka (JP); Shinji TOYOFUKU, Fukuoka (JP)

(73) Assignee: PANASONIC CORPORATION, Osaka (JP)

(21) Appl. No.: 13/542,959

(22) Filed: Jul. 6, 2012

(30) Foreign Application Priority Data
Jul. 8, 2011 (JP) 2011-151574

(51) Int. Cl. G11B 33/02

(52) U.S. Cl. 720/600; G9B/33.002

(57) ABSTRACT

In an optical disk device (1), the generation of noises can be avoided even when a pressure or any other stress is applied to the wall of the housing (50) of the optical disk device, and the wall of the housing is caused to come into contact with a disk retaining assembly (11) of the optical disk device that may be rotating. A shaft (32) projecting centrally from the optical disk retaining assembly and the opposing wall of the housing is provided with a spherical tip (32a) at a free end thereof.

### BACKGROUND OF THE INVENTION

1. Field of the Invention

The present invention relates to an optical disk device for reading and writing information from and into an optical disk such as CD and DVD.

2. Description of the Related Art

Desktop computers and laptop computers are commonly incorporated with an optical disk device. In particular, it is essential for the optical disk device for laptop computers to be compact and lightweight as laptop computers are required to be compact and lightweight.

Therefore, the optical disk device for laptop computers is received in a highly compact housing, and the gap between the housing of the optical disk is small and the opposing wall of the drive bay of the laptop computer is extremely small. Also, the component parts for the optical disk device are selected from those having small sizes and weights, and the components are arranged at a high density.

Typically, the optical drive disk of a laptop computer is placed on the backside or below the keyboard thereof. Therefore, the optical disk device could be affected by the operation of the keyboard. In particular, the component parts of the laptop computer are arranged so close to one another that the pressure that is applied to the keyboard may be transmitted to the optical disk device.

More specifically, when some pressure is applied to the keyboard of the laptop computer, the wall of the drive bay may be brought into contact with the housing of the optical disk device. The wall of the housing of the optical disk device is so small that such a pressure may cause a bending of the wall of the housing, and the wall may come into contact with the disk retaining assembly of the optical disk device. When the disk retaining assembly is rotating, the contact between the wall of the housing and the disk retaining assembly could cause an unpleasant noise.

FIG. 7 shows a fragmentary sectional view showing a conventional optical disk device. The optical disk device is provided with a disk retaining assembly 11 for supporting the central part of an optical disk, and the disk retaining assembly 11 rotates along with the optical disk during the operation of the optical disk device. A shaft 32 which is fitted into a hole of a disk retaining assembly 11 is provided with a flat tip which is slightly sunk in the hole. In other words, the tip of the shaft 32 does not protrude from the disk retaining assembly 11. Therefore, when the user applies a significant pressure onto the keyboard of the computer, the pressure may cause the upper wall of the housing of the optical disk device to bend downward to such an extent that the disk retaining assembly 11 comes into contact with the upper wall of the housing of the optical disk device. When the optical disk device is in use, and the disk retaining assembly 11 is rotating, the friction between the upper wall of the housing of the optical disk device and the disk retaining assembly 11 may cause an unpleasant noise. Also, because the tip of the shaft 32 is recessed with respect to the upper end of the hole 14, a recess is defined by the upper end of the shaft 32 and the surrounding wall surface of the hole, and this recess may trap debris or other foreign matters.

### BRIEF SUMMARY OF THE INVENTION

In view of such problems of the prior art, a primary object of the present invention is to provide an optical disk device that can avoid the generation of noises in a reliable manner even when a pressure or any other stress is applied to the wall of the housing of the optical disk device to such an extent as to cause a contact between the wall of the housing and the disk retaining assembly of the optical disk device that may be rotating.

A second object of the present invention is to provide an optical disk device which is to be incorporated in a laptop computer or any other similar portable device that can avoid the generation of noises in a reliable manner even when a pressure or any other stress is applied to the wall of the housing of the optical disk device via a keyboard or any other part of the portable device, and causes a contact between the wall of the housing and the disk retaining assembly of the optical disk device that may be rotating.

To achieve such an object, the present invention provides an optical disk device, comprising: an optical disk retaining assembly; a rotational drive unit for rotationally driving the optical disk retaining assembly around a central axial line; a housing receiving the optical disk retaining assembly and the rotational drive unit, and including a wall opposing the optical disk retaining assembly; and a shaft projecting centrally from the optical disk retaining assembly coaxially with the central axial line toward the wall; wherein the shaft is provided with a spherical tip at a free end thereof.

Even when the wall of the housing opposing the optical disk retaining assembly is deformed and brought into contact with the optical disk retaining assembly, a relatively small friction is caused, and the emission of noise is minimized. Therefore, the optical disk device is not required to be provided with a highly stiff structure so that the optical disk device can be constructed as a highly compact and lightweight structure without requiring excessive costs.

This is particularly significant when the spherical tip of the shaft projects toward the upper wall of the housing more than any other part of the optical disk retaining assembly.

According to a preferred embodiment of the present invention, the shaft has a constant outer diameter, and the spherical tip of the shaft has a substantially same outer diameter as the outer diameter of the shaft.

According to a particularly preferred embodiment of the present invention, a sheet or a coating having a lower frictional coefficient than the wall is placed on a part of a surface of the wall opposing the spherical tip of the shaft.

Typically, the rotational drive unit includes an electric motor, and the shaft consists of a rotational output shaft of the electric motor which is fixedly passed through the optical disk retaining assembly.

### BRIEF DESCRIPTION OF THE SEVERAL VIEWS OF DRAWINGS

Now the present invention is described in the following with reference to the appended drawings, in which:

FIG. 1 is a perspective view of a laptop computer incorporated with an optical disk device embodying the present invention;

FIG. 2 is a sectional view showing a disk retaining assembly of the optical disk device;

FIG. 3 is a fragmentary sectional view showing the relationship between a housing wall of the optical disk device and a shaft thereof when no pressure is applied to a keyboard of the laptop computer in a first embodiment of the present invention;

FIG. 4 is a fragmentary sectional view showing the relationship between the housing wall of the optical disk device and the shaft thereof when some pressure is applied to the keyboard of the laptop computer in the first embodiment of the present invention;

FIG. 5 is a view similar to FIG. 3 showing a second embodiment of the present invention;

FIG. 6 is a view similar to FIG. 4 showing the second embodiment of the present invention; and

FIG. 7 is a view similar to FIG. 4 showing a conventional structure.

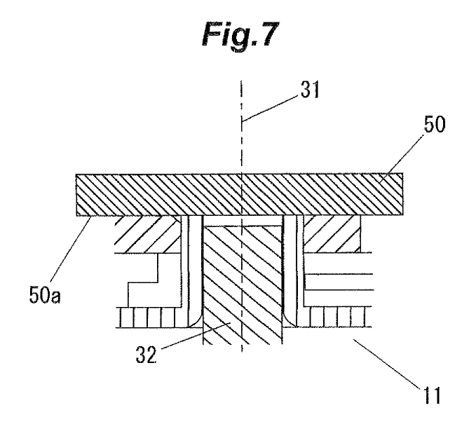

### DETAILED DESCRIPTION OF THE INVENTION

Now a first embodiment of the present invention is described in the following with reference to the appended drawings.

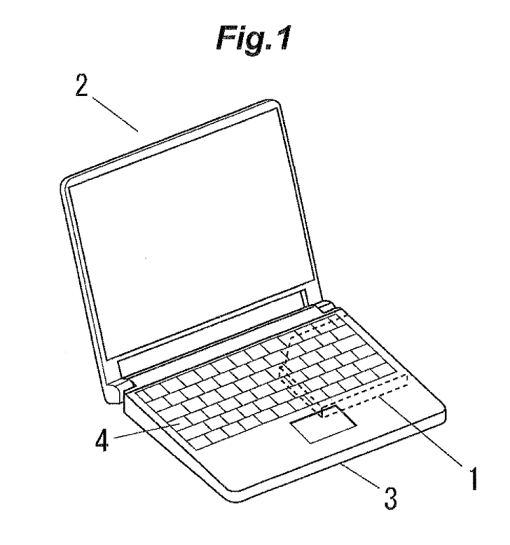

FIG. 1 is a perspective view of a laptop computer 2 incorporated with an optical disk device 1 embodying the present invention. The laptop computer 2 includes a keyboard 4 provided on a main body 3 thereof; and an optical disk device 1 is installed inside the main body 3 behind the keyboard 4. The optical disk device 1 includes a disk tray that can be retracted and drawn sideways into and out of a housing of the optical disk device 2 in a similar manner as a desk drawer to enable an optical disk to be mounted and dismounted on and from the optical disk device 2. Alternatively, the optical disk device 1 may consist of a slot-in type optical disk device that allows an optical disk to be inserted and ejected into and from the optical disk device via a slot in the housing, instead of using a disk tray.

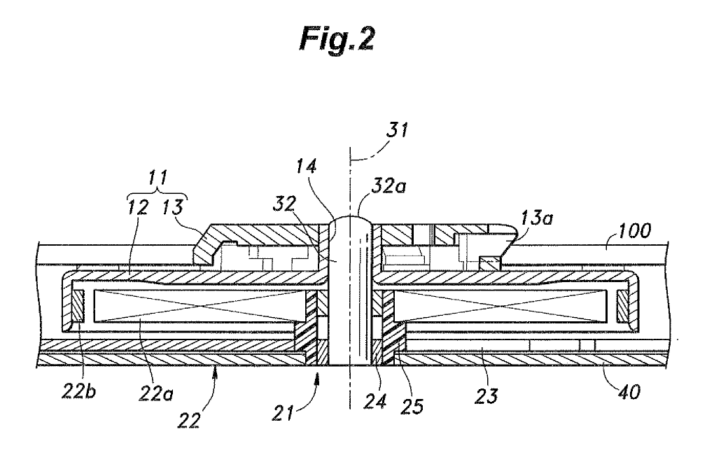

FIG. 2 is a sectional view showing a disk retaining assembly 11 of the optical disk device 1. The disk retaining assembly 11 includes a turntable 12 for supporting an optical disk 100 thereon, and a disk retaining member 13 fixedly connected to the turntable 12 and fitted with claw members 13a that are resiliently urged toward the turntable 12. The optical disk 100 can be held in position by being interposed between the turntable 12 and the claw members 13a.

The optical disk device 2 further comprises a rotational drive unit 21 consisting of an electric motor 22 for producing a rotating drive force and a circuit board 23 incorporated with an electronic circuit required for controlling the electric motor 22. The electric motor 22 includes a stator 22a consisting of coils and fixedly secured to a base plate 40 via a central hub member 25, and permanent magnets 22b attached to the turntable 12 so as to oppose the stator 22a at a regular angular interval. The coils of the stator 22a are connected to the printed circuit board 23 via a flexible printed circuit board or other wiring arrangement which is not shown in the drawings.

A shaft 32 having a central axial line 31 is passed through a through hole 14 formed in the disk retaining assembly 11, and is fixedly connected to the disk retaining assembly 11. The shaft 32 is preferably made of metallic member such as steel which may be plated with suitable material so as to demonstrate a relatively low frictional coefficient. The base end of the shaft 32 is rotatably supported in the hollow interior of the hub member 25 via a bearing 24. The shaft 32 is coaxial with the optical disk 100 supported on the turntable 12, and transmits the rotational force of the rotational drive unit 21 to the disk retaining assembly 11. The free end of the shaft 32 protrudes above the disk retaining assembly 11, and is provided with a spherical tip 32a.

The base plate 40 supports the rotational drive unit 21, and therefore determines the position of the disk retaining assembly 11 via the shaft 32. The base plate 40 further supports a carriage (not shown in the drawings) which in turn moveably supports an optical assembly including an object lens for directing a laser beam onto the optical disk 100.

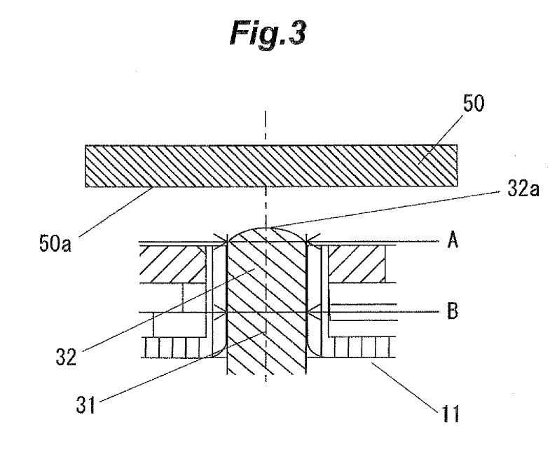

FIG. 3 is a fragmentary sectional view showing the relationship between a housing wall of the optical disk device 1 and the shaft 32 thereof when no pressure is applied to the keyboard 4 of the laptop computer 2 in the first embodiment of the present invention. The housing 50 encases at least the disk retaining assembly 11 and the rotational drive unit 21 of the optical disk device 1. The inner surface 50a of the upper wall of the housing 50 opposes the disk retaining assembly 11, in particular the spherical tip 32a of the shaft 32.

The shaft 32 is coaxial with the rotational center of the optical disk 100, and transmits the rotational force of the rotational drive unit 21 to the optical disk 100 via the disk retaining assembly 11. The spherical tip 32a formed at the free end or upper end of the shaft 32 protrudes above the entire part of the disk retaining assembly 11, and opposes the inner surface 50a of the upper wall of the housing 50.

In particular, in the illustrated embodiment, the outer diameter A of the outer periphery of the spherical tip 32a is equal to the outer diameter B of the part of the shaft 32 adjacent to the spherical tip 32. In the illustrated embodiment, the shaft 32 is provided with a constant outer diameter B substantially over the entire length thereof.

The spherical tip 32a of the shaft 32 protrudes entirely out of the hole 14 of the disk retaining assembly 11. A certain gap is defined between the spherical tip 32a of the shaft 32 and the opposing inner surface 50a of the upper wall of the housing 50 so that the contact between the spherical tip 32a and the opposing inner surface 50a is avoided under normal condition. Therefore, the shaft 32 is allowed to rotate without causing any friction or noise under normal circumstances

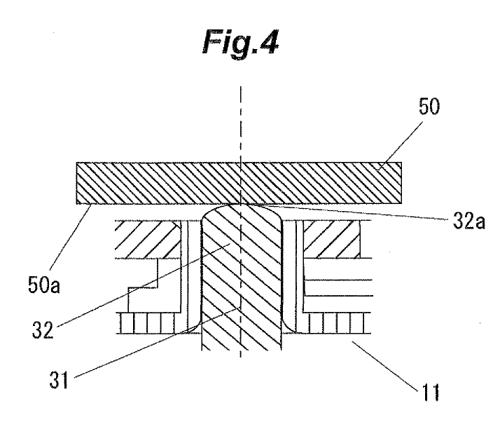

FIG. 4 is a fragmentary sectional view showing the relationship between the housing wall of the optical disk device and the shaft 32 thereof when some pressure is applied to the keyboard 4 of the laptop computer 2 in the first embodiment of the present invention.

When the user of the laptop computer 2 presses down the keyboard 4, the pressure may be transmitted to the upper wall of the housing 50 of the optical disk device 1. As the upper wall has a relatively small thickness (for the compact and lightweight design of the optical disk device), and the gap between the optical disk retaining assembly 11 and the opposing inner surface 50a of the upper wall of the housing 50 is small (for the compact and lightweight design of the optical disk device), the opposing inner surface 50a of the upper wall of the housing 50 may be brought into contact with the spherical tip 32a of the shaft 32. Because the spherical tip 32a of the shaft 32 causes a relatively small friction to the opposing inner surface 50a of the top wall of the housing 50, the noise that may be created by the contact is relatively slight. Because the tip 32a is spherical, even when the opposing inner surface 50a of the top wall of the housing 50 contacts at an angle relatively to the shaft 32, the friction is prevented from increasing to any substantial extent.

The spherical shape of the tip 32a of the shaft 32 can be semi-spherical such that the radius of curvature of the spherical tip 32a is substantially equal to the radius of the remaining part of the shaft 32. Alternatively, the radius of curvature of the spherical tip 32a may be substantially greater than the radius of the remaining part of the shaft 32 such that the tip 32a is provided with a part-spherical shape which is consists of a smaller section of a sphere than a semi-sphere.

Also, because the tip 32a of the shaft 32 protrudes entirely out of the hole 14 of the optical disk retaining assembly 11, the force of attachment between the shaft 32 and the optical disk retaining assembly 11 can be maximized. Furthermore, no recess is defined around the tip 32a of the shaft 32 so that the deposition of foreign matters in such a recess can be avoided.

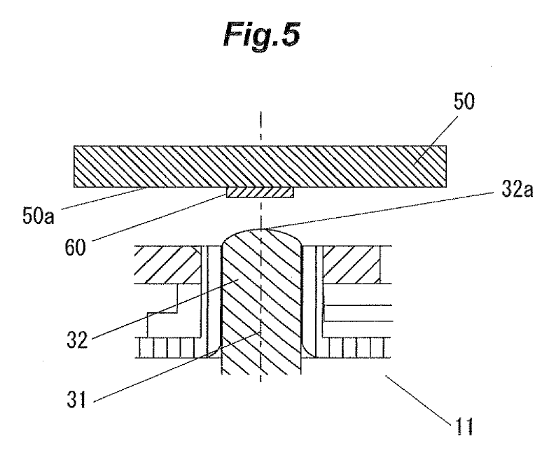

FIG. 5 is a view similar to FIG. 3 showing a second embodiment of the present invention. In the description of the second embodiment, the parts corresponding to those of the previous embodiment are denoted with like numerals without repeating the description of such parts. This embodiment differs from the first embodiment in that a piece of sheet member 60 is affixed to a part of the inner surface of the upper wall of the housing 50 opposing the spherical tip 32a of the shaft 32. The sheet member 60 has a lower frictional coefficient than the inner surface of the upper wall of the housing 50.

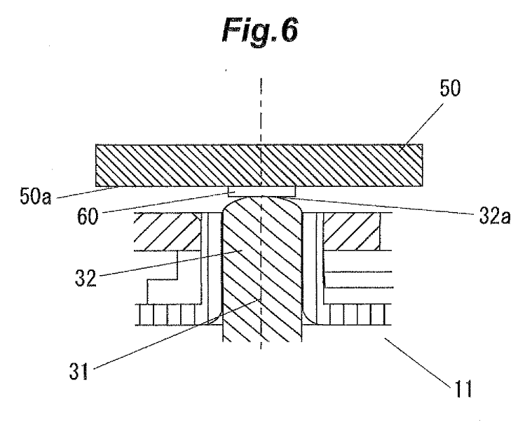

In this case also, as shown in FIG. 6, when a significant pressure is applied to the keyboard 4, the opposing inner surface 50a of the top wall of the housing 50 may be brought into contact with the spherical tip 32a of the shaft 32. As the spherical tip 32a of the shaft 32 engages the opposing inner surface 50a of the top wall of the housing 50 via the sheet member 60, the friction caused between the spherical tip 32a of the shaft 32 and the opposing inner surface 50a of the upper wall of the housing 50 is even smaller than that of the first embodiment, and the noise that may be created at such a time is even smaller than that of the first embodiment.

Instead of using a sheet member, it is also possible to apply a coating of low friction material on the opposing surface 50a of the upper wall of the housing 50.

In the foregoing embodiment, the shaft 32 consisted of an output shaft or a central shaft of the electric motor which rotates with the rotor of the electric motor. However, the shaft may also consist of any coaxial rod member that protrudes from the top surface of the disk retaining assembly, and may also consist of a protrusion formed in a part of the disk retaining assembly. The material of the shaft of the tip thereof is not limited to metallic material but may also consist of low friction plastic material such as polytetrafluoroethylene plastic. Also, the term “spherical” as used herein shall mean any roundish contour which is free from irregularities that could cause undue friction, and may include conical, frusto-conical, hyperbolic and other roundish contours.

The optical disk device of the present invention is highly useful for use in devices for recording and reading information in and from optical disks such as CD and DVD because the noises that may be created when a housing of the device is brought into contact with a rotating part of the device due to the pressure that is applied to a part of the device is minimized. The present invention is particularly useful when the recording/playing device is constructed as a highly compact and lightweight unit, and therefore lacks an adequate mechanical stiffness that can prevent the contact between a rotating part and the housing of the device.

The present invention was described in terms of specific embodiments, but the present invention is not limited by the illustrated embodiments, and can be modified in various parts thereof without departing from the spirit of the present invention.

The contents of the original Japanese patent application on which the Paris Convention priority claim is made for the present application as well as the contents of the prior art references mentioned in this application are incorporated in this application by reference.

1. An optical disk device, comprising:
an optical disk retaining assembly;
a rotational drive unit for rotationally driving the optical disk retaining assembly around a central axial line;
a housing receiving the optical disk retaining assembly and the rotational drive unit, and including a wall opposing the optical disk retaining assembly; and
a shaft projecting centrally from the optical disk retaining assembly coaxially with the central axial line toward the wall;
wherein the shaft is provided with a spherical tip at a free end thereof.

2. The optical disk device according to claim 1, wherein the spherical tip of the shaft project toward the wall more than any other part of the optical disk retaining assembly.

3. The optical disk device according to claim 1, wherein the shaft has a constant outer diameter, and the spherical tip of the shaft has a substantially same outer diameter as the outer diameter of the shaft.

4. The optical disk device according to claim 1, wherein a sheet or a coating having a lower frictional coefficient than the wall is placed on a part of a surface of the wall opposing the spherical tip of the shaft.

5. The optical disk device according to claim 1, wherein the rotational drive unit includes an electric motor, and the shaft consists of a rotational output shaft of the electric motor which is fixedly passed through the optical disk retaining assembly.
